(19) United States
(12) Patent Application Publication
(10) Pub. No.: US 2013/0332184 A1
(43) Pub. Date: Dec. 12, 2013

(54) SYSTEM AND METHOD FOR REDUCING HEALTHCARE-ASSOCIATED INFECTIONS

(71) Applicant: KIMBERLY-CLARK CORPORATION, Roswell, GA (US)

(72) Inventors: Jason Andrew Burnham, Roswell, GA (US); Sudhanshu Gakhar, Neenah, WI (US); Stephanie Michelle Martin, Johns Creek, GA (US); Alan Shuman, Roswell, GA (US); Surabhi Mahapatra, Washington, DC (US); Clay Edward Maxwell, Washington, DC (US); Timothy Joseph Ogilvie, Washington, DC (US)

(21) Appl. No.: 13/916,218

(22) Filed: Jun. 12, 2013

Related U.S. Application Data
(60) Provisional application No. 61/658,892, filed on Jun. 12, 2012.

(51) Int. Cl. G06Q 10/06; G06Q 50/22

(52) U.S. Cl. CPC G06Q 10/0635; G06Q 50/22
USPC 705/2

(57) ABSTRACT

Systems and methods for reducing the incidence of healthcare-associated infections (HAIs) are described. Embodiments of the present invention empower and educate patients and their advocates, while providing proximate (and in some cases, real-time) feedback to health care workers (HCWs) regarding their compliance with known protocols that reduce the risk of healthcare-associated infections.

### BACKGROUND OF THE INVENTION

1. Field of the Invention

The present invention relates to healthcare, and in particular, to systems and methods for reducing healthcare-associated infections.

2. Description of Related Art

Healthcare-associated infections (HAIs) are an expensive problem in healthcare, and many, if not most, can be prevented through proper hand hygiene, surface hygiene, and compliance with methods of providing care. HAIs are infections not originating from a patient's admitting diagnosis, and can be caused by any infectious agent, such as bacteria, fungi, viruses, and other less common pathogens. The most common forms of HAIs are catheter associated urinary tract infection (CAUTI), surgical site infection (SSI), clostridium difficile-associated disease (CDI or c-diff), central line associated bloodstream infections (CLABSI), ventilator-associated pneumonia (VAP), methicillin-resistant staphylococcus aureus infections (MRSA), and pressure ulcers (PU). HAIs can occur in any clinical environment, including same-day surgical centers, acute care within hospitals, ambulatory settings, urgent care centers, outpatient clinics, and long-term care facilities, such as rehabilitation facilities and nursing homes.

Risk factors for developing an infection can be bucketed into three overarching categories: iatrogenic (stemming from treatment, e.g., inadequate hand sanitization), organizational (environmental elements like HVAC or other system design features, e.g., contaminated water supply), and patient-related (e.g., compromised immune system, or length of stay). In short, HAIs are caused by microorganisms transmitted by indwelling devices, the improper cleansing of materials, surgical procedures (i.e., contamination during), misapplication of antibiotics, transmission of disease between individuals, and environmental contamination. These largely come about because of lack of protocol compliance—from inadequate sanitation to skipped steps in patient preparation. Importantly, there is little tying the occurrence of an HAI to its cause, i.e., there is minimal transparency to the process, numerous hand-offs (thus communication gaps), and little to no individual liability for a negative outcome.

Based on studies published by the Centers for Disease Control and Prevention, it is estimated that the overall annual direct medical costs of HAIs to U.S. hospitals ranges from $28.4 to $33.8 billion. By implementing possible infection control interventions, it is estimated that as much as $25.0 to $31.5 billion of this cost can be avoided. If supported properly, healthcare workers can modify their behavior to comply more fully with known anti-HAI protocols. The obstacles to compliance include low involvement from patients, weak healthcare worker awareness/education systems, lack of real-time feedback, and difficulty in linking downstream outcomes with upstream behaviors.

There are numerous mitigating products and strategies that exist in various levels of implementation today, such as antimicrobial sheets and plastics, hand sanitation stations, HAI prevention protocol, antiseptic wipes, etc. These are all aimed at reducing HAIs, yet, while these demonstrate varying levels of efficacy, there are deeper issues at play. For example, this challenge can be an issue of behavior modification.

### SUMMARY OF THE INVENTION

Thus, there exists a need for systems and methods for reducing healthcare-associated infections that increase protocol compliance, raise awareness of HAIs as an unacceptable occurrence, tie HAI rates to incurred costs for a clinic and thus a lower bottom line, empower the patient and patient advocate as contributors to HAI prevention, and manage hospital reputation around HAI prevalence. Embodiments of the invention meet this need and others by focusing on modifying the behavior of the key participants in the clinical setting. This is accomplished by providing (1) greater awareness, education and engagement, (2) real-time feedback on behaviors, and (3) clear lines of visibility to downstream outcomes. Embodiments of the invention depend upon information technology to generate data (rather than relying on overburdened healthcare workers). Described embodiments deliver that data indirectly to HCWs through their Infection Control/Preventionist (ICP), and, where appropriate, directly to HCWs through their personal handset or clinic-based terminals.

The persons involved in implementing the described embodiments include, but are not limited to: patient (the person receiving care in a clinic setting), family member (a person who supports the patient by being present in their home before and after the procedure, and/or visiting the clinical setting), advocate (a person who advocates for the patient's wellness and care, without being employed by the clinic practice, who may be the same person as the family member or a different person or third party), healthcare workers (HCW) (a member of a clinic care team, including but not limited to a physician, anesthesiologist, nurse, nurse's aide, physical therapist, etc.), care team (the collective group of HCWs that are caring for a given patient), infection control/preventionist (ICP) (a person employed by the clinic to help prevent infections through awareness, education and training, setting of procedures, data analysis and reporting, etc.), and others. “Clinical environments” as used herein refers to a hospital, rehab facility, outpatient surgery center, or any other environment where regulated health services are provided. “Third party administrator” as used herein refers to an off-site provider of the HAI-reduction system, that may administer system software, remote sensors, clinic-based data uplink devices, hand-held applications, game accounts, data reporting, etc.

According to one embodiment, a method for reducing healthcare-associated infections comprises developing infection reduction protocol, enrolling healthcare workers in an infection reduction program using the infection reduction protocol, associating each healthcare worker with a unique identifier within the infection reduction program, installing sensors at strategic locations, tracking the healthcare workers and the sensors to determine compliance with the infection reduction protocol, and providing feedback to the healthcare workers regarding compliance with the infection reduction protocol.

According to another embodiment, another method for reducing healthcare-associated infections is described. The method comprises placing a sensor in a strategic location, receiving data from the sensor, analyzing the data to determine compliance with a behavior, aggregating the data over a period of time to determine trends in the behavior, and providing feedback based on the trends in behavior.

According to a further embodiment, a system for reducing healthcare-associated infections is described. The system comprises a user identification module associated with a user configured to transmit user identification information, a sensor configured to obtain and transmit the user identification information and data indicative of the user's compliance with a behavior, a control unit configured to analyze the data to determine the user's compliance with the behavior, and a display configured to provide feedback to the user regarding compliance with the behavior.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a storyboard illustrating a system and method for reducing healthcare-associated infections in accordance with an embodiment of the invention.

FIG. 2 is a schematic diagram illustrating a system for reducing healthcare-associated infections in accordance with an embodiment of the invention.

FIG. 3 is a schematic diagram illustrating modules of a system of an embodiment for effecting the methods described herein.

FIG. 4 is diagrammatic representation of a machine having a set of instructions for causing the machine to perform any of the one or more methods described herein.

### DETAILED DESCRIPTION

Systems and methods for reducing healthcare-associated infections are described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement.

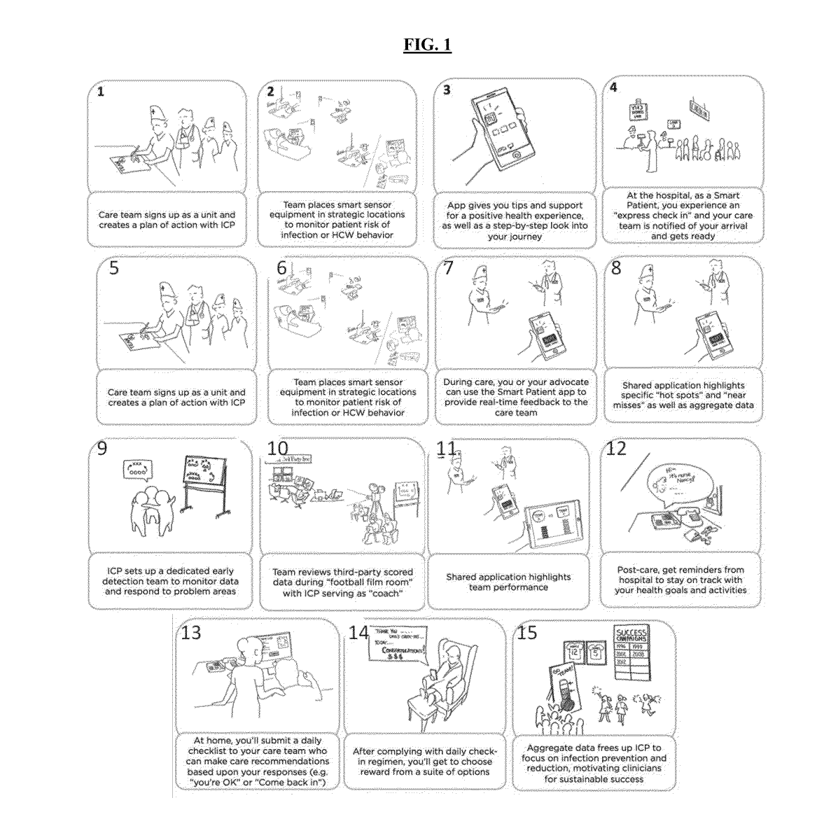

Referring now to the drawings, FIG. 1 is a storyboard illustrating a system and method for reducing healthcare-associated infections in accordance with one implementation of the invention. At panel 1, the patient fills out his or her personal “infection prevention” profile, highlighting habits and history to define health goals and responsibilities. This engages the patient, a key stakeholder who is typically omitted from the infection-prevention regimen. The provided personal history helps the patient's clinical care team to understand his or her infection risk profile. Data might include type of surgery, age, weight, BMI, smoker, prior cDiff or MRSA episodes, etc. In this way, the care system can flag high-risk HAI patients. There may be special pre-procedure routines depending upon the patient's unique needs. The patient is taught what to expect in their procedure, and the patient identifies his or her advocate, another stakeholder typically omitted by infection-prevention protocols.

The patient can enroll in a Zero-HAI game, where they understand their role as part of a care team to attain a Zero-HAI procedure. The patient can pay for the opportunity to play in this game using an “infection insurance” program. For example, the patient can pay $200 for infection insurance in the same way they might buy “trip insurance” for an airline ticket; if they have to cancel the trip, the airline or insurer would refund most of their money, less a premium. In this case of “infection insurance”, the patient might understand that they can earn a $150 rebate it they come through their procedure with no infections.

The system can use other motivators besides financial ones to create a game. For example, it can be a social game where an age 60-plus patient enrolls his adult children and grandchildren in supporting him remotely (i.e., online) as he undergoes a procedure. The promise of a healthy procedure for his granddaughter may be the key to motivating his compliance with zero-HAI protocols.

At panel 2, the patient receives a “get smart” kit with infection prevention videos, dietary recommendations prior to surgery, other care and education tips, as well as assorted health products, such as hand sanitizer, surface disinfectant wipes, CHG soap for bathing, etc. The “get smart” kit reinforces the contribution being asked from the patient and the advocate by providing artifacts that serve as cues before and during the procedure. Video training, whether on a CD or served from an online website, uses the patient's mirror neurons to trigger imitative behavior. That is, they may be shown the way to clean their sutures at home after surgery, or how to take their antibiotics with food. When this information is received with images of people acting it out, the compliance rates are significantly higher.

At panel 3, the patient received a software application (i.e., an “app”) for their smart phone. Alternatively or additionally, the patient may be sent an iPod Touch, iPad or other device. The app may be used to enroll them in a Zero-HAI game, as described previously with respect to panel 1. The app gives the patient tips and support for a positive health experience, as well as a step-by-step look into their journey. Meanwhile, pre-visit mining can be completed of peer group hospital and procedure experience data and opinions, such as on blogs, charts, forums and rankings.

At panel 4, the patient receives treatment preferences just as an elite frequent flyer might. For example, at the hospital, as a “smart patient”, the patient can experience an “express check-in” and their care team can be notified of their arrival and get ready. This reinforces the sense of a game worth playing, makes the patient again mindful of their HAI-prevention goal, and signals the care team about the special stakes for this patient. It also triggers the care team to start a game session.

At panel 5, the care team signs up as a unit and creates a plan of action with the ICP. The care teams at participating hospitals and clinical environments can opt-in to an HAI-reduction system that provides them with feedback and group rewards. The system can be presented as a game, where points are earned and prizes are awarded based upon achievement thresholds. This game can be administrated by the ICP, along with a third party administrator that operates the system. Each HCW has a personal account. Their account gives them a unique identified that tracks their interactions with different elements of the system, as described in further detail herein.

At panel 6, the care team places smart sensor equipment in strategic locations in and around the clinic setting to monitor patient risk of infection or HCW behavior as part of their challenge to achieve Zero-HAIs. Alternatively or additionally, the ICP or the third-party administrator chooses where to place the sensor components. These choices depend upon the goals of the installation, including the perceived “hot spots” for that clinical practice that may contribute to reducing HAIs. Strategic locations could be bedside, on/near catheter sites, on medications, at sinks/hand-washing stations, on sanitizer dispensers and/or on personal protective equipment (PPE) dispensers. These types of sensors include digital camera, image recognition algorithms (in which the software learns to recognize the typical movements, and flags movements that do not comply), motion sensors, RFID systems, near-field communications, infra-red, proximity readers, accelerometers, wrist-worn bracelets with personalized receivers and/or transmitted to connect behaviors (e.g., hand washing) with specific HCWs and other players, and/or a central communications module to receive signals from the various sensors.

In one embodiment, catheter tracking can be implemented to prevent catheter-associated urinary tract infections (CAUTI) or blood stream infections. In this embodiment, patients with central venous catheters or Foley catheters are tagged with an RFID, along with the clinician. Catheter insertion can be “time stamped” to trigger removal reminders. Reminders can also be generated for hand-washing, catheter cleaning and hygiene, donning of personal protective equipment (PPE), catheter positioning, and use of chlorhexidine gluconate (CHG) preps before catheterization. The care team places smart sensors to track catheter usage, hand washing before touching patient, donning of PPE, use of CHG preps before catheterization, and catheter care activities after insertion. In this embodiment, the sensors used include RFIDs, accelerometers on CHG bottles, PPE counters for usage, and hand washing counters for clinicians.

In another embodiment, sensors can be used to prevent ventilator-associated pneumonia (VAP). For example, a patient incubated with an endotracheal tube (ET) can be tagged with an RFID, along with a bed angle greater than 30 degrees, and an oral care kit. In this embodiment, the care team places smart sensors to track bed angle, hand washing before touching patient, donning of personal protective equipment (PPE), and oral care kit usages. The sensors used include RFIDs, accelerometers on the oral care kit, tilt sensors for bed angle, PPE counters for usage, and hand washing counters for clinicians.

In placing the sensor network, the goal is to allow the HCWs to focus exclusively on providing patient care, without stopping to interact with any feedback devices. In other words, the system seeks to use zero-HCW active input. If a HCW picks up a bottle of anti-microbial solution, the system has an accelerometer on the bottom of the solution which knows the bottle has been used, and the HCW is wearing a unique ID bracelet which links the activity to that specific player. This data is uploaded when the HCW is in proximity to a central upload device, or alternatively, when the HCW ends his or her shift and syncs up manually with the game system, such as through a USB drive. Another method of transferring data from the sensor network can be through an embedded wireless network, such as passive RFID (UHF or HF), active RFID (915 MHz ISM band), ZigBee network (802.15.4 std at 2.4 GHz), or existing WiFi 802.11b/g/n network (2.4 GHz).

As described above, a key part of embodiments of the system is the automated links between activities by the HCW and the HAI-reduction system. The HCW signs up to participate (opt-in) or is required to sign up. The HCW receives a unique ID within the system. The HCW dons a wearable receiver and/or transmitter. This could be a bracelet that is color-coded to indicate their achievement level within a belt-color system, and could be embedded in a color-coded glove (akin to martial arts “black belt” system).

When an HCW washes their hands, a sensor near the hand-wash station would record their presence and duration of stay. When an HCW is near a patient with a catheter, for example, a proximity reader (or transmitter) on/near the catheter site can state the anti-HAI protocol. The HCW can then follow the protocol and “swipe” their bracelet near the proximity reader or transmitter. Thus, although the system intends to minimize the extra steps by the HCW, “swiping” or passing the bracelet near a sensor is considered minimal and acceptable. The system will not (or will only minimally) rely on keystrokes by HCWs, except in the break room or training room, and away from the patient care environment.

If the bracelet is a receiver, then it might have a USB capability such that the HCW uploads the device to a fixed terminal and the end of his/her shift. The upload activity alone could earn points in the systems, or there could even be a flat payment per day for uploading data.

At panel 7, the patient or his or her advocate can bring the smart device to the clinic with them for the procedure. In the event that they may be under medication, the smart device will be placed near them and at times it will signal the HCW to interact with it. For example, if the patient has a central line catheter that needs to be cleaned out every 12 hours, the handset can have an alarm that alerts the care team. To turn off the alarm, the HCW can signal that the catheter site cleaning protocol was followed. This allows the system to record the specific HCW that executed the protocol and award points to the HCW and the care team that he or she is working for.

In addition, the “Smart Patient” app can allow the patient (or his or her advocate) to provide real-time feedback to the care team. If they seem to be omitting an HAI protocol, the patient could send a query to the care team. If they are going above and beyond the patient's expectations, the patient can indicate his or her gratitude. Thus, a sense of shared goal is provided, and a real-time method of communication is captured by the system (with visibility to the ICP for data analysis purposes).

At panel 8, the system might also have a hand-held smart device for use by the HCWs. In this event, the HCW could use it to see hot spots and receive alerts. For example, a urinary catheter becomes a likely source of infection after four days. Often, they can be pulled by day 4, but care teams may forget to check this. The system or app can have a urinary catheter countdown clock, and can push out proactive alarms on day 4. Any HCW that checks the catheter and removes it if appropriate would earn points in the game.

“Near misses” are a key piece of data that very few clinical settings capture. The ICP could set a near-miss protocol and enroll care teams to begin capturing it for research purposes. This type of analytic data is one of the main obstacles to addressing and reducing HAIs.

For example, with respect to catheter tracking, the clinician can get a reminder for catheter care, such as catheter usage exceeding three days (for a Foley catheter) or seven days (for a center line), bandage change/hub care of a center line, etc. The shared application highlights best practices for catheter care including dressing changes and CHG scrubs, as well as aggregates data on compliance of key activities.

In another example, with respect to ventilator-associated pneumonia, the clinician can get a reminder for VAP care, such as sedation vacation every twenty-four hours, oral care every four to six hours, and bed angle less than thirty degrees. The shared application highlights the best practices for ventilator care, such as oral care, sedation vacation, and bed angle, as well as aggregates data on compliance of key activities.

Recommended Anti-HAI Protocols

TABLE 1
Central Line

| | |
|---|---|
| Recommended Practices | |
| (SHEA/APIC/IDSA) | What to track (Examples) |

During Insertion

| | |
|---|---|
| Hand hygiene | Hand hygiene |
| Maximum Barrier protection | PPE use (caps, gloves, gowns. Mask) |
| caps, mask, gloves and gown | |
| Cover the patient with | Drape usage/sterile field maintenance |
| sterile drape | |
| Skin prep with Alcoholic | CHG/Antiseptic usage |
| CHG solution | |
| Use Checklist at insertion | Compliance/automatically filled - |
| | reduce extra work for clinicians |

After insertion Center Line care

| | |
|---|---|
| Daily CHG bathing | Activity Check for CHG usage |
| Change Dressings every 3 days | Reminder/Activity check for |
| followed by CHG site cleaning | dressing change |
| and Scrub the Hubs during | |
| dressing change and every | |
| time hubs are used | |
| Use Biopatch or medicated | Reminder/Activity check for |
| disc at dress site | dressing change |
| Do not leave the Center Line | reminder for catheter usage |
| in for more than 7 days | |
| Antiseptic catheter flush | reminder for catheter flush |
| if CL is left unused | |

TABLE 2
Foley Catheter

| | |
|---|---|
| Recommended Practices | |
| (SHEA/APIC/IDSA) | What to track (Examples) |

UTI Care

| | |
|---|---|
| Hand hygiene | Hand hygiene |
| Standard Barrier protection gloves | PPE use (gloves, gowns) |
| and gown | |
| Cover the patient with sterile drape | Drape usage/sterile field |
| | maintenance |
| Skin prep with Alcoholic CHG solution | CHG/Antiseptic usage |

After insertion Cath- care

| | |
|---|---|
| Daily CHG cleaning of perennial region | Activity Check for CHG usage |
| Ensure collection bag is below the | Reminder/Activity check |
| level of the bladder | |
| Do not leave the Catheters in for | track catheter usage |
| more than 2 days | |

TABLE 3
VAP Care

| | |
|---|---|
| Recommended Practices | |
| (SHEA/APIC/IDSA) | What to track (Examples) |

VAP Care

| | |
|---|---|
| Elevate bed angle >30 deg | Bed elevation |
| Oral care every 4 hrs | oral are kit usage |
| Sedation vacation every 24 hours to minimize | Reminder/Activity check |
| duration on Mechanical ventilation | |
| Maintain cuff pressure at 20-30 mm | Cuff pressure monitor |
| Drain subglottic fluid every day | Activity monitor |
| DVT Prophylaxis - Heparin Prescription | Activity monitor |

At panel 9, ICPs are empowered to set up a dedicated early detection team to monitor data and respond to problem areas. Currently, ICPs spend most of their time providing government-mandated reports. The vast majority of the data must be manually-created. The ICPs' potential to empower care teams to make real improvements is quite limited. With the described embodiments of the HAI-reduction system, there is an opportunity for ICPs to become problem solvers and value-added partners to the clinical teams they support. ICPs can go from an administrative/reporting function to an asset for clinic performance and patient safety improvement.

At panel 10, sensor data can be used to provide a “Monday morning football film room” capability. The care team can review third-party scored data during the “football film room” with the ICP serving as “coach”. The described embodiments of the system can aggregate the data on a periodic basis, such as weekly, and provide analytics to the ICP, the care team, or both. If the video is used to watch compliance with catheter protocols, for example, the video can be “scored” off-set as a measure of care team compliance. Film clips could then be made of the “better” behaviors and the “questionable” behaviors. Embodiments of the system could anonymize the HCWs (e.g., by blurring their faces) if appropriate, while still giving the care team live examples of their own performance, instead of showing them actors.

At panel 11, the shared application highlights team performance. Team-based feedback is provided to care teams, as well as individual feedback to HCWs. Progress is shown and people are given regulator reminders not to skip over the HAI-prevention protocols. Embodiments of the feedback system can set “alarm” thresholds if hand-washing frequency falls below a minimum level, for example, and alert people at all levels in the system. Similarly, embodiments can have a “green status” tone that is given when consecutive days or shifts are achieved above a set threshold.

One of the areas of vulnerability for clinical environments is post-discharge from the acute care environment. The patient invariably is released well before full recovery. They may be briefed on their post-discharge care plan while groggy and disoriented or distracted. Then they return home, without a nurse to ask questions of, and may forget or neglect to care for their wound and/or comply with post-procedure antibiotics.

Embodiments of the described invention allow the care experience to continue at home. At panel 12, the patient can get reminders from the hospital to stay on track with health goals and activities post-care. The daily checklist might include medication adherence, clinician appointments, physical therapy, diet restrictions, wound care instructions, etc. Using the same smart device, tailored messages can be teed-up from the care team to the patient. For example, a text message can come that says, “Mr. Green, don't forget to take your Zithromax each day until it is gone. Please text me today after you have taken it.” When Mr. Green sends the text message, both he and his care team receive points for their compliance. If appropriate, the advocate may respond on behalf of Mr. Green.

At panel 13, the at-home experience continues with the patient submitting a daily checklist to the care team who can make care recommendations based upon the patient's responses, e.g., “you're OK” or “come back in”. The at-home experience can include a full computer interface, wherein the patient and/or his or her advocate can submit more complete updates to the care team. For example, the patient can have a virtual visit where he shows the wound site to the care team over Skype, sends in his blood pressure and 02 levels, etc. Alternatively, the care team can send images to the patient showing, “A normal wound looks like this after 4 days. Does your wound look: (A) less red, (B) similar, or (C) more red?”. Post discharge, medication usage and symptoms (e.g., pain, temperature) can be monitored.

Thus, the notion of acute care can continue over into a more cost-effective setting. This at-home connection can capture much more accurate reporting of HAIs, which is one of the obstacles for solving this expensive problem for our health care and patient safety system.

At panel 14, after complying with the daily check-in regimen, the patient can choose a reward from a suite of options. If the “HAI insurance” model described with respect to panel 1 is used, the patient will send back the smart device and receive a full or partial rebate. The patient might also have $100 to allocate to his care team for their anti-HAI efforts on his behalf. This micro-bonus system could go a long way to creating “anti-HAI heroes” within a care team and raising the visibility of these mundane, time-consuming procedures that have an outsize effect on health care costs.

At panel 15, aggregate data frees up the ICP to focus on infection prevention and reduction, motivating clinicians for sustainable success. The previous panels have focused on real-time and near-real-time feedback, which is an acute challenge in the fight against HAIs. Equally important, however, is the need to link the eventual patient outcome with the upstream behaviors when treating that patient. If a nurse fails to wash her hands and passes c-diff from one patient to another, there is no unambiguous marker that show that it was that particular nurse and that particular instance of omitted hand-washing that is to blame. However, the clinical environment today does not even capture hand-washing frequency in any form.

Embodiments of the described system capture behavioral compliance with many anti-HAI protocols. With respect to panel 15, it is contemplated that the eventual outcomes of patients would be correlated back to the overall compliance behaviors of the HCWs in the clinic during the time that patient was being treated. This is not the basis for assigning blame to an individual action, but it is more than ample basis for upgrading overall compliance within a clinic, setting new norms, and setting the ICP up to change his/her role as a partner to the clinic's success.

Specific applications of embodiments of the invention include analytics tying compliance to reduced infections, infection data, or infection indications such as nosocomial infection markers (NIM) (CC-BSI/VAP/CAUTI), aggregate data and feeds into ESS systems to track compliance to reduction in NIM, and analytics reduction of NIM (CC-BSI/VAP/CAUTI) to increased revenue and reduced LOS for hospitals and payers. Statistics can include catheters placed, average duration of catheter, catheter removal time compared to hospital average, number of UTIs, number of UTIs compared to hospital average, hand-washing compliance stats, near misses, near misses compared to hospital average, patient satisfaction scored, etc.

Thus, embodiments of the invention provide feedback in the moment, to support behavior change, and will link behavioral data with downstream outcomes to allow the infection control/preventionist (ICP) within a clinical setting to experiment with new protocols, then track the protocols to downstream health outcomes, and thus improve their HAI performance. This improvement will both improve patient safety and reduce health system cost. Additional system applications that can benefit workflow and efficiencies include culture and lab diagnostics prioritization, tracking of mobile capital equipment locations, and monitoring staff and visitor traffic flow.

In one embodiment of the invention, a method is provided to walk patients and/or HCWs through the steps of pressure ulcer assessments. Rapid computerized scoring can be provided based on recognition of photos and matching to a database, and in one example, can be directly uploaded to the patient's chart or reported to the payer. Pressure sensors can actively monitor areas of the body prone to ulceration. Reminders can be generated to HCWs to turn patients and change bandages, as well as confirmations based on manually entered or automatically sensed data. Communications can be made to the patient post-discharge regarding pressure ulcers, how to prevent them, what to looks for, etc., and sensors can be used to detect when an area of their body (e.g., ankles) are being subjected to too much pressure.

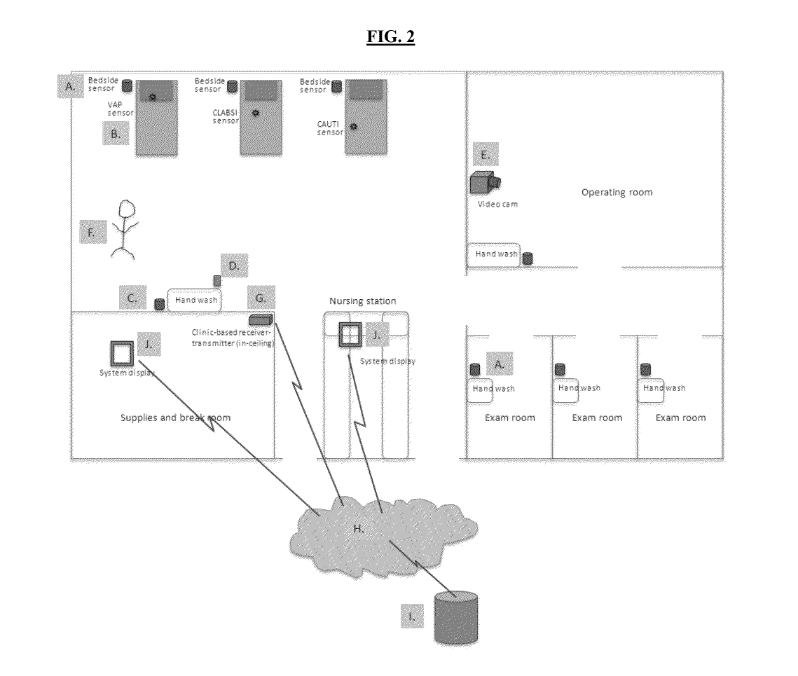

FIG. 2 is a schematic diagram illustrating a system for reducing healthcare-associated infections in accordance with an embodiment of the invention. Sensors are set up in the clinical area, including bedside sensors (A), specialty sensors for specific HAI risks (B), hand wash sensors (C), anti-microbial dispenser sensors (D), and video cameras (E). Beside sensors (A) and other disclosed sensors can include prevention sensors, e.g., sensors to detect unlocked bed rails. Position sensors can also be used to detect whether a patient has fallen, the patient's position in bed, whether “babysitters” are present in the room when used, etc. Information from such sensors can be used to generate alerts, e.g., that a patient is in danger of falling or has fallen, reminders to check a patient's position in bed, whether the “babysitter” is present, etc.

Specialty sensors for specific HAI risks (B) can include sensors associated with or integrated into a ventilator (e.g., a VAP sensor), a central line (e.g., a CLABSI sensor), a Foley catheter (e.g., a CAUTI sensor), or the like. These types of sensors can perceive changes that may suggest infection. For example, the sensors can sense heat or temperature changes, chemical changes, bacteria counts, etc., and can communicate that information to indicate a possible HAI or HAI risk. In one embodiment, these types of sensors are associated with existing treatment systems (i.e., are integral or connected to those components), such that further invasive techniques are not necessary to install or monitor the sensor.

When a HCW interacts near the sensor, anti-HAI protocol compliance information is registered through interaction with a sensor worn by the worker (F). This sensor might be part of a bracelet, or glove, or otherwise worn on the body. In one embodiment, it operates in a hands-free way, either through near-field communications, proximity sensing, infra-red, or other low-power, short distance communications method. The data can be received through a clinic-based receiver transmitter (G), or else through manual uploading to a central system (J). Once uploaded, it can be routed to the clinical IT system, possibly routed through the cloud (H). Analytics can be performed by software (I) that may reside off-site, or on the clinical IT system. The results can be routed back to the clinic to be available through the clinical system display (J). HCWs can receive feedback in near-real-time, and clinical performance can be tied to team or individual games and rewards.

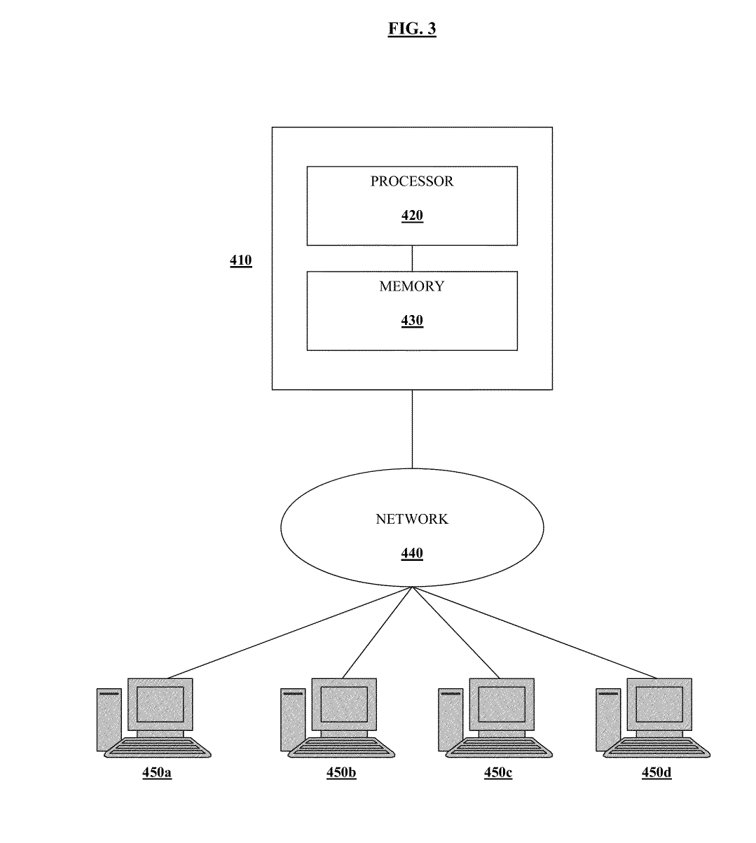

FIG. 3 illustrates server 410 that is connected over network 440 to a plurality of user devices 450. Server 410 includes processor 420 and memory 430, which are in communication with one another. Server 410 is configured to transmit and receive information from users at the plurality of user devices 450a-d. Server 410 is typically a computer system, and may be an HTTP (Hypertext Transfer Protocol) server, such as an Apache server. Memory 430 may be any type of storage media that may be volatile or non-volatile memory that includes, for example, read-only memory (ROM), random access memory (RAM), magnetic disk storage media, optical storage media, flash memory devices, and zip drives. Network 440 may be a local area network (LAN), wide area network (WAN), a telephone network, such as the Public Switched Telephone Network (PSTN), an intranet, the Internet, or combinations thereof. The plurality of user devices 450a-d may be mainframes, minicomputers, personal computers, laptops, personal digital assistants (PDAs), cell phones, televisions, MP3 players, tablet PCs, game consoles, book readers, sensors, and the like. The plurality of user devices 450a-d are characterized in that they are capable of being connected to network 440.

Although described with respect to particular devices or sensors, it is understood that a variety of similar devices may be employed to perform the processes described herein. The functions of these and other embodiments can be described as modules of computer executable instructions recorded on tangible media. The modules can be segregated in various manners over various devices.

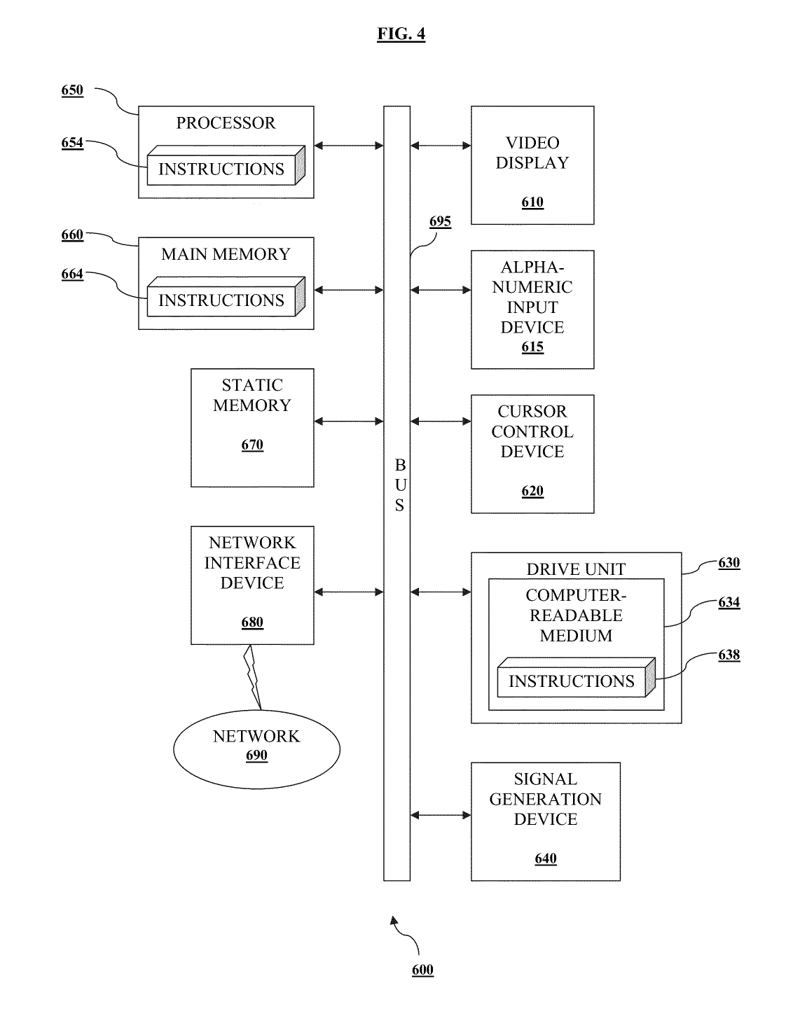

FIG. 4 shows a diagrammatic representation of machine in the exemplary form of computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, a game console, a television, an MP3 player, a laptop, a book reader, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

According to some embodiments, computer system 600 comprises processor 650 (e.g., a central processing unit (CPU), a graphics processing unit (GPU) or both), main memory 660 (e.g., read only memory (ROM), flash memory, dynamic random access memory (DRAM) such as synchronous DRAM (SDRAM) or Rambus DRAM (RDRAM), etc.) and/or static memory 670 (e.g., flash memory, static random access memory (SRAM), etc.), which communicate with each other via bus 695.

According to some embodiments, computer system 600 may further comprise video display unit 610 (e.g., a liquid crystal display (LCD) or a cathode ray tube (CRT)). According to some embodiments, computer system 600 also may comprise alphanumeric input device 615 (e.g., a keyboard), cursor control device 1320 (e.g., a mouse), disk drive unit 630, signal generation device 640 (e.g., a speaker), and/or network interface device 680.

Disk drive unit 630 includes computer-readable medium 634 on which is stored one or more sets of instructions (e.g., software 638) embodying any one or more of the methodologies or functions described herein. Software 638 may also reside, completely or at least partially, within main memory 660 and/or within processor 650 during execution thereof by computer system 600, main memory 660 and processor 650 also constituting computer-readable media. Software 638 may further be transmitted or received over network 690 via network interface device 680.

While computer-readable medium 634 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the disclosed embodiments. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the methods described herein. Those skilled in the art will appreciate that many different combinations of hardware, software, and firmware will be suitable for practicing the disclosed embodiments.

The present invention has been described in relation to particular examples, which are intended in all respects to be illustrative rather than restrictive. Those skilled in the art will appreciate that many different combinations of materials and components will be suitable for practicing the present invention.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A method for reducing healthcare-associated infections comprising:
developing infection reduction protocol;
enrolling healthcare workers in an infection reduction program using the infection reduction protocol;
associating each healthcare worker with a unique identifier within the infection reduction program;
installing sensors at strategic locations;
tracking the healthcare workers and the sensors to determine compliance with the infection reduction protocol; and
providing feedback to the healthcare workers regarding compliance with the infection reduction protocol.

2. The method of claim 1, wherein the unique identifier is comprised on at least one of an RFID tag, an RFID badge, an RFID arm band, an RTLS tag, an RTLS badge, and an RTLS arm band.

3. The method of claim 1, wherein the sensors comprise at least one of proximity sensors, hand sanitizer usage sensors, gyroscopes, accelerometers, bed angle sensors, antiseptic medication usage sensors, and video cameras.

4. The method of claim 1, further comprising enrolling at least one of patients, family members, caregivers, and advocates in the infection reduction program.

5. The method of claim 4, wherein the infection reduction program comprises at least one of an educational video, infection reduction products and an identification badge.

6. The method of claim 1, wherein the infection reduction protocol comprises a bundle of care activities for at least one of urinary catheter care, central line catheter care, respiratory care and post-surgical incision care.

7. The method of claim 6, wherein the bundle of care activities comprises at least one of hand hygiene; donning caps; donning masks; donning gloves; donning gowns; sterile protection; skin prep; CHG bathing; dressing changes; medicated disc usage; interventions for catheter usage and removal; antiseptic catheter flush; monitoring bed angle; interventions for timely oral care; interventions for weaning patients from endotracheal tubes; maintaining cuff pressure; surface cleaning protocol including measurement of biological organism count or type on a set of prescribed surfaces; surface decontamination as prescribed by passive or active cleaning such as long-lasting disinfectants or wipes; and ongoing surveillance of surface contamination after the cleaning activities.

8. A method for reducing healthcare-associated infections comprising:
placing a sensor in a strategic location;
receiving data from the sensor;
analyzing the data to determine compliance with a behavior;
aggregating the data over a period of time to determine trends in the behavior; and
providing feedback based on the trends in behavior.

9. The method of claim 8, further comprising:
associating each healthcare worker and patient with a unique identifier.

10. The method of claim 8, wherein the sensors comprise at least one of proximity sensors, hand sanitizer usage sensors, gyroscopes, accelerometers, bed angle sensors, antiseptic medication usage sensors, and video cameras.

11. The method of claim 8, further comprising:
transmitting the data to a central system.

12. The method of claim 11, wherein the data is transmitted wirelessly.

13. The method of claim 12, wherein the data is transmitted using a passive RFID (UHF or HF), active RFID (915 MHz ISM band), ZigBee network (802.15.4 std at 2.4 GHz), or existing WiFi 802.11b/g/n network (2.4 GHz).

14. The method of claim 8, further comprising:
displaying at least one of the data, the aggregated data and the trends in behavior.

15. The method of claim 8, wherein the feedback comprises reporting correlating at least one of compliance with the behavior and the trends in behavior to infection prevention.

16. The method of claim 8, wherein the feedback comprises at least one of patient care materials and patient safety materials correlating to compliance with the behavior.

17. The method of claim 8, further comprising:
requiring acknowledgement of feedback.

18. The method of claim 8, wherein the behavior comprises at least one of hand hygiene; donning caps; donning masks; donning gloves; donning gowns; sterile protection; skin prep; CHG bathing; dressing changes; medicated disc usage; interventions for catheter usage and removal; antiseptic catheter flush; monitoring bed angle; interventions for timely oral care; interventions for weaning patients from endotracheal tubes; maintaining cuff pressure; surface cleaning protocol including measurement of biological organism count or type on a set of prescribed surfaces; surface decontamination as prescribed by passive or active cleaning such as long-lasting disinfectants or wipes; and ongoing surveillance of surface contamination after the cleaning activities.

19. The method of claim 8, wherein the strategic location is at least one of a healthcare worker, a patient, a caregiver, an advocate, and an object.

20. A system for reducing healthcare-associated infections comprising:
a user identification module associated with a user configured to transmit user identification information;
a sensor configured to obtain and transmit the user identification information and data indicative of the user's compliance with a behavior;
a control unit configured to analyze the data to determine the user's compliance with the behavior; and
a display configured to provide feedback to the user regarding compliance with the behavior.

21. The system of claim 20, wherein the control unit comprises a wireless receiver.

22. The system of claim 20, wherein the display is further configured to display infection control tips and messages.

23. The system of claim 20, wherein the control unit is further configured to aggregate the data over a period of time to determine trends in behavior.

24. The system of claim 23, wherein the display is further configured to display the trends in behavior.

25. The system of claim 20, further comprising:
an alert module configured to alert the user if the user is noncompliant with the behavior.

26. The system of claim 20, wherein the sensor comprises a proximity sensor, a hand sanitizer usage sensor, a bed angle sensor, an antiseptic medication usage sensor, or a video camera.

27. The system of claim 20, wherein the control unit is placed inside a patient room.
